(19) United States
(12) Patent Application Publication
(10) Pub. No.: US 2026/0274618 A1
(43) Pub. Date: Sep. 17, 2026

(54) METHOD OF COMMISSIONING AN ELEVATOR SYSTEM, ELEVATOR SYSTEM AND METHOD OF PROVIDING POWER TO A LANDING OPERATING PANEL

(71) Applicant: INVENTIO AG, Hergiswil (CH)

(72) Inventor: Antonio Perfetto, Ebikon (CH)

(21) Appl. No.: 19/168,170

(22) PCT Filed: Mar. 25, 2024
(86) PCT No.: PCT/EP2024/057920

§ 371 Date: Sep. 23, 2025

(30) Foreign Application Priority Data
Mar. 30, 2023 (EP) 23165518.4

(51) Int. Cl. B66B 19/00; B66B 1/34; B66B 1/46

(52) U.S. Cl. CPC B66B 19/00; B66B 1/3461; B66B 1/467

(57) ABSTRACT

A method of commissioning an elevator system is described. The method includes sensing for a presence of an elevator car in front of a landing door at a landing of the elevator system and upon detecting the presence of the elevator car in front of the landing door: switching on a power transmitter; wirelessly providing power from the power transmitter to a power receiver provided in a landing door operating panel mounted on a movable door panel of the landing door; bringing a wireless connector of the landing door operating panel into an operation mode for pairing; bringing a further wireless connector of the landing door controller into an operation mode for pairing; and pairing the landing door operating panel with the landing door controller by establishing a wireless connection between the wireless connector and the further wireless connector.

### TECHNICAL FIELD

Embodiments of the present disclosure relate to methods of commissioning elevator systems, elevator systems, particularly elevator systems suitable for passenger transport, and methods of providing power to landing operating panels of elevator systems.

### BACKGROUND

Passenger transportation systems, such as elevators, escalators or moving walkways, are in general permanently installed in structures and are used to transport people vertically and/or horizontally in the structures.

Due to varying local conditions in different structures and different requirements for functions to be fulfilled by a passenger transportation system, passenger transportation systems used for different purposes can differ considerably, in particular with regard to the components installed therein and/or the way in which these components are operated.

For example, an elevator to be used in a high building can differ from an elevator to be used in a lower building with regard to many properties and components, i.e., for example, with regard to the size of an elevator car, a weight of a counterweight, a length of rope-or belt-like suspension elements, a performance of a drive machine, a dimensioning of brakes, a number of anchors, etc. The way in which the components of the elevator are installed and operated can also differ depending on the location and/or the intended use.

When planning a passenger transportation system, it is first configured with regard to the components to be provided therein. Among other things, local conditions such as those prevailing in the structure accommodating the passenger transportation system, local regulations which specify, for example, which safety precautions must be realized in the passenger transportation system, as well as individual user requests which, for example, indicate which conveying capacities the passenger transportation system should provide and/or which comfort functions must be provided, are taken into account. Information that reflects a configuration of the passenger transportation system resulting therefrom can be stored, for example, in a type of configuration list or bill of materials (BOM) in which, among other things, all components and parts to be included in the passenger transportation system are specified, possibly with additional specifications of further functional and/or structural properties of said components and parts.

After all components and parts have been installed in the passenger transportation system and before the passenger transportation system is put into operation, a so-called commissioning of the passenger transportation system usually takes place. During this commissioning, the special configuration of an individual passenger transportation system with regard to the components and parts it contains is prepared for its intended use and operation. For example, the individual components and parts must be suitably adapted with regard to their respective properties and functions in order to be able to jointly implement actions for the entire passenger transportation system.

For example, within the scope of a commissioning of an elevator system, properties of drive devices, braking devices, elevator doors, control devices, warning or alarm devices, etc. to be provided therein can be set in the above-mentioned example for a suitable interaction and for implementing overall properties to be achieved for the elevator system. In particular, properties of an elevator controller that controls the various components acting in the elevator system and coordinates their operation with one another should be suitably set within the scope of the commissioning.

Conventionally, the commissioning of a passenger transportation system is a very elaborate process in which well-trained personnel has to carry out a multiplicity of complex and possibly interdependent work steps. The commissioning of the passenger transportation system can therefore be associated with significant costs and expenditure of time. Furthermore, due to the complexity of a commissioning process, the risk of faults occurring which can endanger the operation, the integrity or even the safety of the passenger transportation system can be significant.

Accordingly, in view of the above, there is a demand for an improved method of commissioning an elevator system and an improved elevator system which at least partially overcome the problems of the state of the art, particularly such that commissioning of an elevator system can be carried out in a simplified, faster, more cost-effective manner and with a reduced risk of faults.

### SUMMARY

In light of the above, a method of commissioning an elevator system, an elevator system and a method of providing power to a landing operating panel according to the independent claims are provided. Further aspects, advantages, and features are apparent from the dependent claims, the description, and the accompanying drawings.

According to an aspect of the present disclosure, a method of commissioning an elevator system is provided. The method includes sensing for a presence of an elevator car in front of a landing door at a landing of the elevator system. Upon detecting the presence of the elevator car in front of the landing door, the method further includes: switching on a power transmitter; wirelessly providing power from the power transmitter to a power receiver provided in a landing door operating panel mounted on a movable door panel of the landing door; bringing a wireless connector of the landing door operating panel into an operation mode for pairing; bringing a further wireless connector of a landing door controller into an operation mode for pairing; and pairing the landing door operating panel with the landing door controller by establishing a wireless connection between the wireless connector and the further wireless connector.

Accordingly, compared to the state of the art, an improved method of commissioning an elevator system is provided. In particular, embodiments of the method of commissioning as described herein beneficially provides for the possibility of wirelessly commissioning an elevator system. Further, embodiments of the method of commissioning as described herein provide the advantage that the amount of wiring and the wiring complexity of electronic components of an elevator system can be reduced. More specifically, power supply wire connections of electronic components mounted on moving parts of an elevator system, e.g. landing door operating panels mounted on movable landing doors, can be eliminated.

According to another aspect of the present disclosure, an elevator system is provided. The elevator system includes an elevator car having a power transmitter. Further, the elevator system includes a plurality of landings. Each landing includes a landing operating panel. The landing operating panel has a wireless connector for establishing a wireless connection with a further wireless connector of a landing door controller of the respective landing. Additionally, each landing includes a power receiver and a battery. The battery is connected with the power receiver and the landing operating panel. The power transmitter is configured for wirelessly providing power to the power receiver of the respective landing.

Accordingly, compared to the state of the art, an elevator system is provided. In particular, embodiments of the elevator system as described herein are beneficially configured for conducting a wireless method of commissioning the elevator system. Further, embodiments of the elevator system as described herein have the advantaged that the amount of wiring and the wiring complexity of electronic components of the elevator system is reduced compared to the state of the art. Moreover, power supply wire connections of electronic components mounted on moving parts of an elevator system, e.g. landing door operating panels mounted on movable landing doors, can be eliminated.

According to a further aspect of the present disclosure, a method of providing power to a landing operating panel of a landing of an elevator system is provided. The method includes wirelessly transmitting power from a power transmitter provided at an elevator car to a power receiver of the landing. The power receiver is connected with a battery which is connected with the landing operating panel. Accordingly, compared to the state of the art, complex power supply wire connections of landing door operating panels can be avoided.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of an elevator system according to embodiments described herein;

FIG. 2 shows a block diagram for illustrating a method of commissioning an elevator system according to embodiments described herein; and

FIG. 3 shows a block diagram for illustrating a method of providing power to a landing operating panel according to embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

Within the following description of the drawings, the same reference numbers refer to the same or similar components. Generally, only the differences with respect to the individual embodiments are described. Unless specified otherwise, the description of a part or aspect in one applies to a corresponding part or aspect in another embodiment as well.

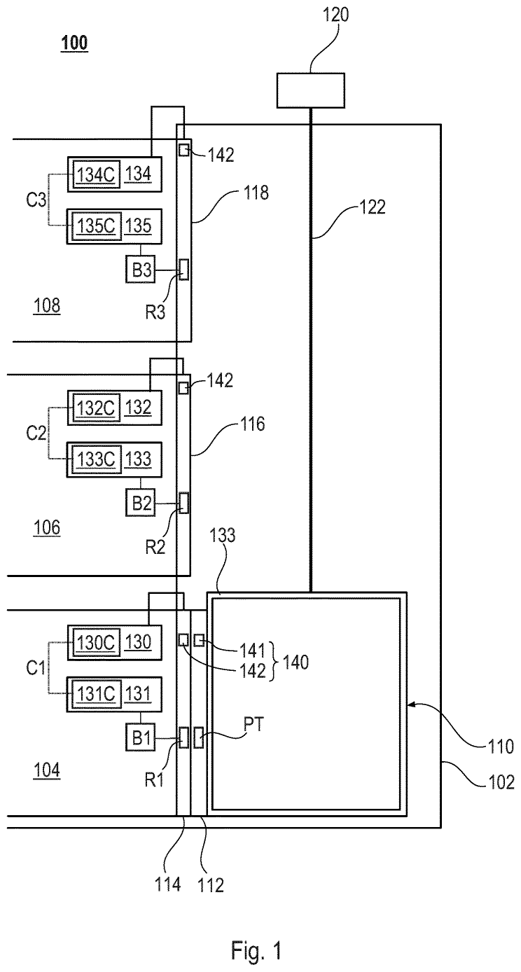

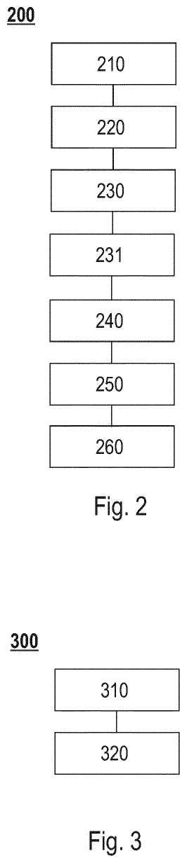

With reference to FIGS. 1 and 2, a method 200 of commissioning an elevator system 100 according to embodiments of the present disclosure is described.

FIG. 1 shows an elevator system 100 having an elevator shaft 102 and an elevator car 110 movably provided in the elevator shaft 102. The elevator car 110 is suspended on a cable 122 which is driven by the drive system 120. Some components of the drive system, such as rollers or counterweights, have been omitted in the figures for clarity. Further drive systems other than the cable-based drive system 120 may be suitable, and the described subject-matter is not limited to the type of drive system shown in the figures.

As shown in FIG. 1, the elevator system 100 has three landings 104, 106 and 108 on different levels, e.g. within a building. The number of landings is exemplary and may be higher or lower. The benefits of the invention may become even more apparent in elevator systems with a large number of landings, e.g. a long elevator shaft 102. The elevator system 100 may have more than 3 landings, more than 5 landings, more than 10 landings or even more than 15 landings.

Each landing 104, 106, 108 has a landing operating panel (LOP) 131, 133, 135 provided in a movable panel of the landing doors 114, 116, 118. The LOP 131, 133, 135 can be configured for allowing a user to interact with the elevator system 100, e.g. call an elevator to the landing. The LOP 131, 133, 135 can be configured for displaying information about the elevator system 100, such as the current position of the elevator car 110, to the user. The LOP 131, 133, 135 can be configured for sending and receiving signals, such as user inputs (e.g. user calls) and/or elevator status information (e.g. a position of the elevator car 110) to and from a control unit (not shown), for instance via a wireless network.

Typically, each landing 104, 106, 108 has a landing door controller 130, 132, 134 configured for controlling the operation of the landing doors 112, 114, 116. The landing door controller 130, 132, 134 can be configured for controlling the opening or closing of the landing doors 114, 116, 118, e.g. by controlling a motor of the landing door 114, 116, 118, and/or by receiving sensor signals of sensors (not shown) provided in the landing door 114, 116, 118. The landing door controller 130, 132, 134 can be configured for receiving a door opening signal or command, e.g. from a control unit, via a wireless network. The landing door controller 130, 132, 134 can be configured for providing information, such as status information, to a receiving unit such as the control unit (not shown).

According to embodiments which can be combined with other embodiments described herein, the method 200 includes sensing (represented by block 210 in FIG. 2) for a presence of an elevator car 110 in front of a landing door 114, 116, 118 at a landing 104, 106, 108 of the elevator system. Upon detecting the presence of the elevator car 110 in front of the landing door 114, 116, 118, the method 200 includes switching on (represented by block 220 in FIG. 2) a power transmitter PT. Further, the method 200 includes wirelessly providing power (represented by block 231 in FIG. 2) from the power transmitter PT to a power receiver R1, R2, R3 provided in a landing door operating panel 131, 133, 135 provided in movable door panel of the landing door 114, 116, 118 at the landing 104, 106, 108 of the elevator system.

As an example, FIG. 1 shows a first power receiver R1 provided in a first landing door operating panel 131 at a first landing 104, a second power receiver R2 provided in a second landing door operating panel 133 at a second landing 106, and a third power receiver R3 provided in a third landing door operating panel 135 at a third landing 108. However, it is to be understood that FIG. 1 shows a non-limiting exemplary embodiment and that more or less than three landings with respective components and elements as described with respect to the landings 104, 106, 108 of FIG. 1 can be provided.

Additionally, the method 200 includes bringing (represented by block 240 in FIG. 2) a wireless connector 131C, 133C, 135C of the landing door operating panel 131, 133, 135 into an operation mode for pairing. Further, the method 200 includes bringing (represented by block 250 in FIG. 2) a further wireless connector 130C, 132C, 134C of a landing door controller 130, 132, 134 into an operation mode for pairing. Moreover, the method 200 includes pairing (represented by block 260 in FIG. 2) the landing door operating panel 131, 133, 135 with the landing door controller 130, 132, 134 by establishing a wireless connection C1, C2, C3 between the wireless connector 131C, 133C, 135C and the further wireless connector 130C, 132C, 134C.

As an example, FIG. 1 shows, a first wireless connector 131C provided at the first landing door operating panel 131, a second wireless connector 133C provided at the second landing door operating panel 133, and a third wireless connector 135C provided at the third landing door operating panel 135. Further, FIG. 1 shows a first landing door controller 130 with a first further wireless connector 130C, a second landing door controller 132 with a second further wireless connector 132C, and a third landing door controller 134 with a third further wireless connector 134C. Moreover, FIG. 1 shows that a first wireless connection C1 can be established between the first wireless connector 131C and the first further wireless connector 130C, a second wireless connection C2 can be established between the second wireless connector 133C and the second further wireless connector 132C, and a third wireless connection C3 can be established between the third wireless connector 135C and the third further wireless connector 134C.

Before various further embodiments of the present disclosure are described in more detail, some aspects with respect to some terms used herein are explained.

In the present disclosure, a “power transmitter” can be understood as a device that is used to transfer electrical power wirelessly from one point to another. Unlike traditional wired electrical power transmission, which requires conductive wires to be physically connected between the power source and the receiver, a power transmitter uses electromagnetic waves to transmit power over a distance without the need for physical contact between the two points. For instance, the power transmitter may use an electromagnetic field to transfer energy between two coils, one on the transmitting side and the other on the receiving side. The transmitting coil generates an alternating current (AC) which creates an electromagnetic field. The receiving coil, placed within this electromagnetic field, picks up the energy and converts it back into electrical power. The amount of power transmitted between the two coils depends on factors such as the distance between the coils, the size of the coils, and the frequency of the alternating current generated by the transmitting coil. The power transmitter can be a resonant power transmitter or a non-resonant power transmitter. A resonant power transmitters uses a resonance circuit to improve power transfer efficiency and reduce losses, while a non-resonant power transmitters use electromagnetic induction to transfer power.

In the present disclosure, a “power receiver” can be understood as a device that is used to receive and convert wirelessly transmitted electrical power into usable electrical energy. As mentioned above, wireless power transfer technology is based on the principle of electromagnetic induction, which involves the transfer of energy between two coils, particularly the transmitting coil of the power transmitter and the receiving coil of the power receiver. Typically, the power receiver is a receiving coil, a rectifier, and a regulator. The receiving coil is used to pick up the energy transmitted by the transmitting coil of the power transmitter. The rectifier is used to convert the AC power received from the transmitting coil into DC power, which is suitable for powering electronic devices. The regulator is used to stabilize the DC voltage and current to ensure that it meets the requirements of the device being powered.

In the present disclosure, a “wireless connector” can be understood as a device used to establish a wireless connection between two devices, allowing them to exchange data or communicate with each other without the need for a physical connection.

With exemplary reference to FIG. 1, according to embodiments which can be combined with other embodiments described herein, the power transmitter PT is provided at an elevator car door 112. The power receiver R1, R2, R3 is provided at a landing door 114, 116, 118 of the landing 104, 106, 108. As an example, FIG. 1 shows a first power receiver R1 provided at a first landing door 114 of the first landing 104, a second power receiver R2 provided at a second landing door 116 of the second landing 106, and a third power receiver R3 provided at a third landing door 118 of the third landing 108.

According to embodiments which can be combined with other embodiments described herein, sensing (represented by block 210 in FIG. 2) for the presence of the elevator car 110 includes using a magnetic sensing device 140. In particular, the magnetic sensing device 140 can be a hall effect sensor, an induction coil or a reed switch. A hall effect sensor is a sensor which uses the Hall effect, i.e. the generation of a voltage across a conductor when it is placed in a magnetic field. Typically, the magnetic sensing device 140 includes a magnet 141 and magnet detection element 142. For instance, the magnet 141 can be provided at the elevator car door 112, as exemplarily shown in FIG. 1. The magnet 141 can be a permanent magnet or an electromagnet. The magnet detection element 142 can be at the landing door 114, 116, 118 of the respective landing 104, 106, 108. In the present disclosure, a “magnet detection element” can be understood as a magnetic sensor that responds to changes in the magnetic field, producing an electrical signal that can be measured and analyzed. For example, the magnet detection element 142 can be an induction coil, a hall effect sensor or a reed switch.

According to embodiments which can be combined with other embodiments described herein, bringing (represented by block 240 in FIG. 2) the wireless connector 131C, 133C, 135C into the operation mode for pairing includes sending out an inquiry request or listening for an inquiry request. Accordingly, bringing (represented by block 250 in FIG. 2) the further wireless connector 130C, 132C, 134C into the operation mode may include listening for an inquiry request or sending out an inquiry request. It is to be understood that the operation modes of the wireless connector 131C, 133C, 135C and the further wireless connector 130C, 132C, 134C match for establishing the connection C1, C2, C3. In other words, when the wireless connector 131C, 133C, 135C sends out an inquiry request the further wireless connector 130C, 132C, 134C listens for an inquiry request or vice versa.

It is to be understood, that when one wireless connector, e.g. the first wireless connector 131C, of the respective landing door operating panel, e.g. the first landing door operating panel 131, is brought into the operation mode for pairing, other wireless connectors, e.g. the second wireless connector 133C and the third wireless connector 135C, provided at different landings, e.g. the second landing 106 and the third landing 108, are either “Off” or “Paired”.

Accordingly, when one further wireless connector, e.g. the first further wireless connector 130C, of the respective landing door controller, e.g. the first landing door controller 130, is brought into the operation mode for pairing, other further wireless connectors, e.g. the second further wireless connector 132C and the third further wireless connector 134C, provided at different landings, e.g. the second landing 106 and the third landing 108, are either “Off” or “Paired”.

According to embodiments which can be combined with other embodiments described herein, the wireless connection C1, C2, C3 is a Bluetooth connection, particularly a low energy Bluetooth connection also known as Bluetooth Low Energy (BLE). The main advantage of BLE is its low power consumption, which makes BLE ideal for use in low-power devices that run on batteries. Further, as compared to classic Bluetooth technology, BLE provides for a faster connection time, since BLE typically uses a simpler connection process.

According to embodiments which can be combined with other embodiments described herein, the method may include charging (represented by block 231 in FIG. 2) a battery B1, B2, B3. As exemplarily shown in FIG. 1, typically the battery B1, B2, B3 is connected with the power receiver R1, R2, R3 and the landing operating panel 131, 133, 135. In particular, as an example FIG. 1 shows a first battery B1 connected with the first power receiver R1, a second battery B2 connected with the second power receiver R2, and a third battery B3 connected with the third power receiver R3.

According to embodiments which can be combined with other embodiments described herein, the method 200 includes using an elevator system 100 according to any embodiments described herein, particularly with reference to FIG. 1. It is to be understood that explanations and features described above with respect to the method 200 of commissioning the elevator system 100 may also apply to the elevator system 100 described in the following.

With reference to FIG. 1, an elevator system 100 according to embodiments of the present disclosure is described. According to embodiments which can be combined with other embodiments described herein, the elevator system 100 includes an elevator car 110 having a power transmitter PT. Further, the elevator system 100 includes a plurality of landings 104, 106, 108. Each landing of the plurality of landings 104, 106, 108 includes a landing operating panel 131, 133, 135. Each landing operating panel 131, 133, 135 has a wireless connector 131C, 133C, 135C for establishing a wireless connection C1, C2, C3 with a further wireless connector 130C, 132C, 134C of a landing door controller 132, 134, 146 of the respective landing 104, 106, 108. Typically, the wireless connection C1, C2, C3 is a Bluetooth connection, particularly a low energy Bluetooth connection. Further, each landing of the plurality of landings 104, 106, 108 includes a power receiver R1, R2, R3 and a battery B1, B2, B3. Typically, the battery B1, B2, B3 is connected with the power receiver R1, R2, R3 as well as with the landing operating panel 131, 133, 135. The power transmitter PT is configured for wirelessly providing power to the power receiver R1, R2, R3 of the respective landing 104, 106, 108.

According to embodiments which can be combined with other embodiments described herein, the power transmitter PT is provided at the elevator car door 112. The power receiver R1, R2, R3 is provided at a landing door 114, 116, 118 of the respective landing 104, 106, 108.

According to embodiments which can be combined with other embodiments described herein, a magnet 141 is provided at an elevator car door 112 and a magnet detection element 142 is provided at a landing door 114, 116, 118 of the landing 104, 106, 108. The magnet 141 and the magnet detection element 142 provide a magnetic sensing device 140 for sensing a presence of the elevator car 110.

With exemplary reference to the block diagram of FIG. 3, a method 300 of providing power to a landing operating panel 131, 133, 135 of a landing 104, 106, 108 of an elevator system 100 according to embodiments of the present disclosure is described. According to embodiments which can be combined with other embodiments described herein, the method 300 wirelessly transmitting power (represented by block 310 in FIG. 3) from a power transmitter PT provided at an elevator car 110 to a power receiver R1, R2, R3 of the landing 104, 106, 108. The power receiver R1, R2, R3 can be connected with a battery B1, B2, B3 which is connected with the landing operating panel 131, 133, 135. Typically, the method 300 includes using (represented by block 320 in FIG. 3) an elevator system 100 according to any embodiments described herein.

Accordingly, in view of the above it is to be understood that embodiments described herein beneficially provide for the possibility of wirelessly commissioning an elevator system. Further, embodiments of the present disclosure have the advantage that the amount of wiring and the wiring complexity of electronic components of the elevator system can be reduced. More specifically, power supply wire connections of electronic components mounted on moving parts of an elevator system, e.g. the landing door operating panels mounted on movable landing doors, can be eliminated.

While the foregoing is directed to embodiments of the disclosure, other and further embodiments of the disclosure may be devised without departing from the basic scope thereof, and the scope thereof is determined by the claims that follow.

### REFERENCE NUMBERS

100 elevator system
102 elevator shaft
104 first landing
106 second landing
108 third landing
110 elevator car
112 elevator car door
113 elevator car frame
114 first landing door
116 second landing door
118 third landing door
120 drive system
122 cable
130 first landing door controller
130C first further wireless connector
131 first movable landing door landing operating panel
131C first wireless connector
132 second landing door controller
132C second further wireless connector
133 second movable landing door landing operating panel
133C second wireless connector
134 third landing door controller
134C third further wireless connector
135 third movable landing door landing operating panel
133C third wireless connector
140 magnetic sensing device
141 magnet
142 magnet
200 method of commissioning an elevator system
210, 220, 230, 231, 240, 250, 260 blocks of block diagram for illustrating embodiments of the method of commissioning an elevator system
300 method of providing power to a landing operating panel
310, 320 blocks of block diagram for illustrating embodiments of the method of providing power to a landing operating panel
PT power transmitter
R1 first power receiver
R2 second power receiver
R3 third power receiver
B1 first battery
B2 second battery
B3 third battery
C1 first wireless connection
C2 second wireless connection
C3 second wireless connection

1.-13. (canceled)

14. A method of commissioning an elevator system, comprising:
sensing for a presence of an elevator car at a landing door at a landing of the elevator system and upon detecting the presence of the elevator car at the landing door:
switching on a power transmitter;
wirelessly providing power from the power transmitter to a power receiver provided in a landing door operating panel mounted on a movable door panel of the landing door;
bringing a wireless connector of the landing door operating panel into an operation mode for pairing;
bringing a further wireless connector of a landing door controller into an operation mode for pairing; and
pairing the landing door operating panel with the landing door controller by establishing a wireless connection between the wireless connector and the further wireless connector.

15. The method of claim 14, wherein the power transmitter is provided at an elevator car door.

16. The method of claim 14, wherein sensing for the presence of the elevator car comprises using a magnetic sensing device.

17. The method of claim 14, wherein bringing the wireless connector into the operation mode for pairing comprises sending out an inquiry request or listening for an inquiry request, wherein bringing the further wireless connector into the operation mode comprises listening for an inquiry request or sending out an inquiry request, and wherein the operation modes of the wireless connector and the further wireless connector match for establishing the connection.

18. The method of claim 14, wherein the wireless connection is a Bluetooth connection, particularly a low energy Bluetooth connection.

19. The method of claim 14, further comprising charging a battery connected with the power receiver and the landing operating panel.

20. A method comprising:
(a) using an elevator system comprising:
an elevator car having a power transmitter,
a plurality of landings, wherein each landing comprises:
a landing door operating panel mounted on a movable door panel of a landing door, wherein the landing door operating panel has a wireless connector for establishing a wireless connection with a further wireless connector of a landing door controller of a respective landing,
a power receiver, and
a battery, wherein the battery is connected with the power receiver and the landing door operating panel,
wherein the power transmitter is configured for wirelessly providing power to the power receiver of the respective landing; and
(b) sensing for a presence of the elevator car at the landing door at the landing of the elevator system and upon detecting the presence of the elevator car at the landing door:
switching on the power transmitter;
wirelessly providing power from the power transmitter to the power receiver provided in the landing door operating panel mounted on the movable door panel of the landing door;
bringing the wireless connector of the landing door operating panel into an operation mode for pairing;
bringing a further wireless connector of the landing door controller into an operation mode for pairing; and
pairing the landing door operating panel with the landing door controller by establishing a wireless connection between the wireless connector and the further wireless connector.

21. An elevator system, comprising:
an elevator car having a power transmitter,
a plurality of landings, wherein each landing comprises:
a landing operating panel mounted on a movable door panel of a landing door, wherein the landing operating panel has a wireless connector for establishing a wireless connection with a further wireless connector of a landing door controller of the respective landing,
a power receiver, and
a battery, wherein the battery is connected with the power receiver and the landing operating panel,
wherein the power transmitter is configured for wirelessly providing power to the power receiver of the respective landing.

22. The elevator system of claim 21, wherein the power transmitter is provided at the elevator car door, and wherein the power receiver is provided at the landing door of the respective landing.

23. The elevator system of claim 21, wherein a magnet is provided at an elevator car door and a magnet detection element is provided at the landing door of the landing, the magnet and the magnet detection element providing a magnetic sensing device for sensing a presence of the elevator car.

24. The elevator system of claim 21, wherein the wireless connection is a Bluetooth connection.

25. The elevator system of claim 21, wherein the wireless connection is a low energy Bluetooth connection.

26. A method of providing power to a landing operating panel of a landing of an elevator system, the method comprising wirelessly transmitting power from a power transmitter provided at an elevator car to a power receiver of the landing, the power receiver being connected with a battery connected with the landing operating panel.

27. The method of claim 26, further comprising using an elevator system comprising:
an elevator car having a power transmitter,
a plurality of landings, wherein each landing comprises:
a landing operating panel mounted on a movable door panel of a landing door, wherein the landing operating panel has a wireless connector for establishing a wireless connection with a further wireless connector of a landing door controller of the respective landing,
a power receiver, and
a battery, wherein the battery is connected with the power receiver and the landing operating panel,
wherein the power transmitter is configured for wirelessly providing power to the power receiver of the respective landing.
